(19) United States
(12) Patent Application Publication
(10) Pub. No.: US 2025/0148943 A1
(43) Pub. Date: May 8, 2025

(54) Golf Cart Mountable Flag Assembly

(71) Applicants: Jonathan Flores, Downey, CA (US); Jose Avilez, Downey, CA (US)

(72) Inventors: Jonathan Flores, Downey, CA (US); Jose Avilez, Downey, CA (US)

(21) Appl. No.: 18/387,900

(22) Filed: Nov. 8, 2023

(51) Int. Cl. G09F 17/00

(52) U.S. Cl. CPC G09F 17/00; G09F 2017/005; G09F 2017/0075

(57) ABSTRACT

A golf cart mountable flag assembly for advertising and promotional purposes includes a clamp, a staff, and a flag. The clamp comprises a pair of jaws that can be opened to receive a rod of a canopy of a golf cart and to be closed to secure the clamp to the rod. A socket having an opening is attached to the clamp so that the opening faces upwardly upon the clamp being secured to the rod. The staff has upper and lower ends, with the lower end being selectively insertable into the socket to attach the staff to the socket and with the staff extending substantially vertically relative to a ground surface. The flag comprises a panel, which has a vertical edge, and a sleeve, which is attached to the panel and which extends along the vertical edge. The staff is insertable into the sleeve.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to flag assemblies and more particularly pertains to a new flag assembly for advertising and promotional purposes. A flag assembly enabling advertising and promotion of businesses, products, organizations, causes, or the like, which is readily attachable to a golf cart would be useful for many golfers.

### (2) Description of Related Art Including Information Disclosed Under 37 CFR 1.97 and 1.98

The prior art relates to flag assemblies, which may include flags attachable to golf carts to indicate wind direction. Prior art flag assemblies may comprise clips to which rotatable bases are attached for receiving flagstaff. What is lacking in the prior art is flag attachable to a golf cart using a clamp having staff receivers oriented at 90° so the clamp can be attached to either a horizontal rod or a vertical rod of the golf cart.

### BRIEF SUMMARY OF THE INVENTION

An embodiment of the disclosure meets the needs presented above by generally comprising a clamp, a staff, and a flag. The clamp comprises a pair of jaws and is configured to be opened to receive a rod of a canopy of a golf cart and to be closed such that the jaws secure the clamp to the rod. A socket having an opening is attached to the clamp so that the opening faces upwardly upon the clamp being secured to the rod. The staff has an upper end and a lower end, with the lower end being complimentary to and selectively insertable into the socket so that the staff is removably attached to the socket and extends substantially vertically relative to a ground surface upon which the golf cart is positioned. The flag comprises a panel, which has a vertical edge, and a sleeve, which is attached to the panel and which extends along the vertical edge. The staff is insertable into the sleeve.

Another embodiment of the disclosure includes a golf cart mounted flag system, which comprises a golf cart and golf cart mountable flag assembly, as described in the disclosure above. A clamp of the golf cart mountable flag assembly is attached to a rod of a canopy of the golf cart so that a staff of the golf cart mountable flag assembly extends substantially vertically relative to a ground surface upon which the golf cart is positioned.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a golf cart mountable flag assembly according to an embodiment of the disclosure.

FIG. 2 is an exploded view of an embodiment of the disclosure.

FIG. 3 is an isometric perspective view of an embodiment of the disclosure.

FIG. 4 is a detail view of an embodiment of the disclosure.

FIG. 5 is a detail view of an embodiment of the disclosure.

FIG. 6 is an in-use view of an embodiment of the disclosure.

FIG. 7 is a detail view of an embodiment of the disclosure.

FIG. 8 is a detail view of an embodiment of the disclosure.

FIG. 9 is an in-use view of an embodiment of the disclosure.

FIG. 10 is an in-use view of an embodiment of the disclosure.

### DETAILED DESCRIPTION OF THE INVENTION

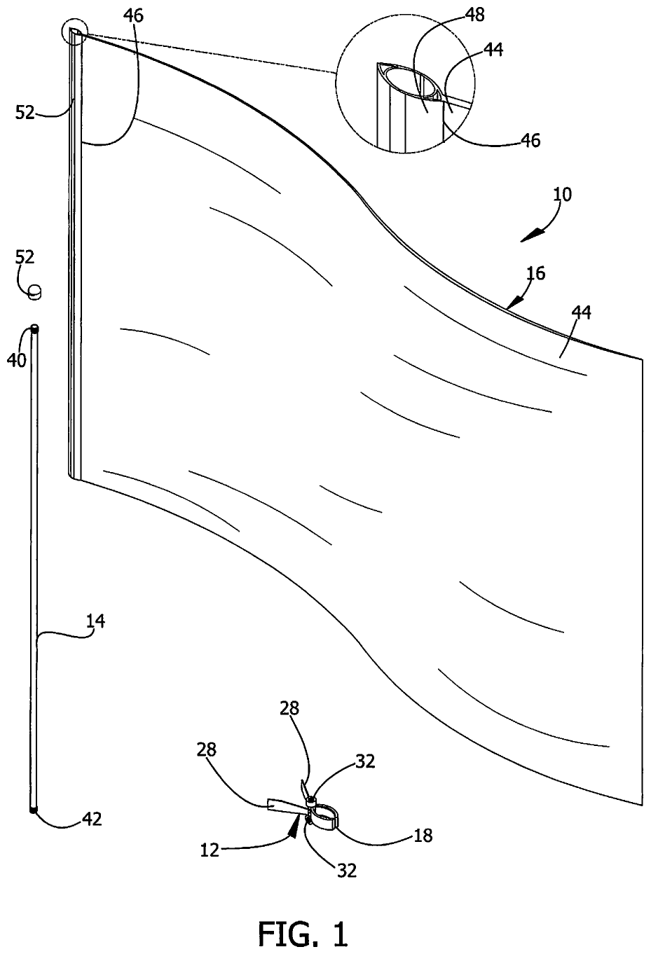

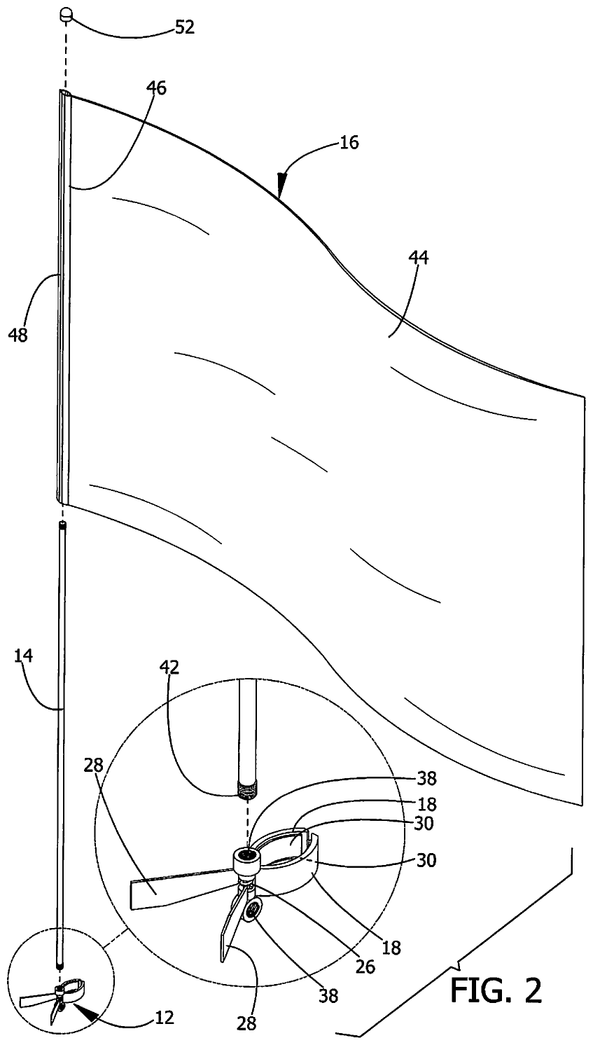

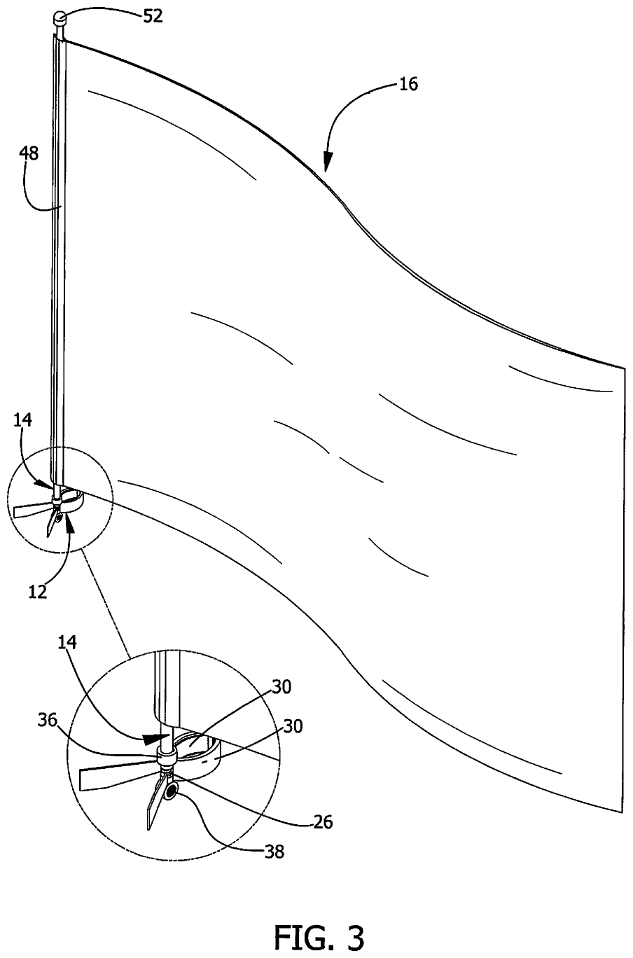

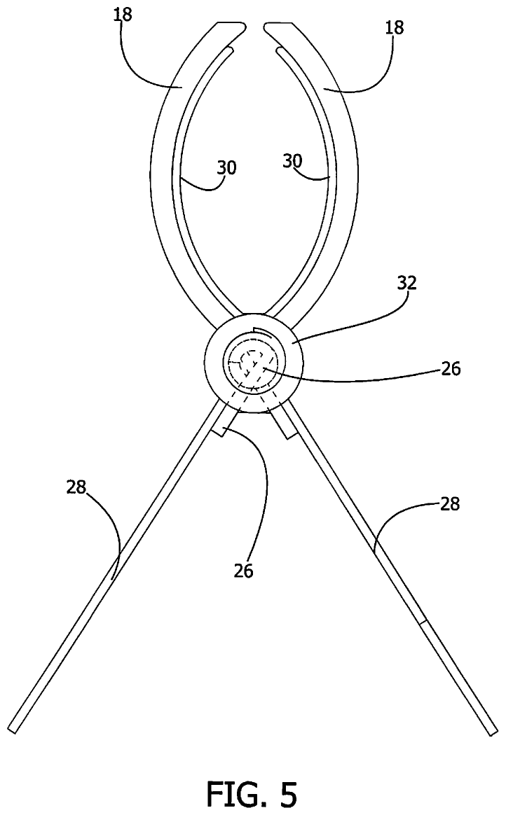

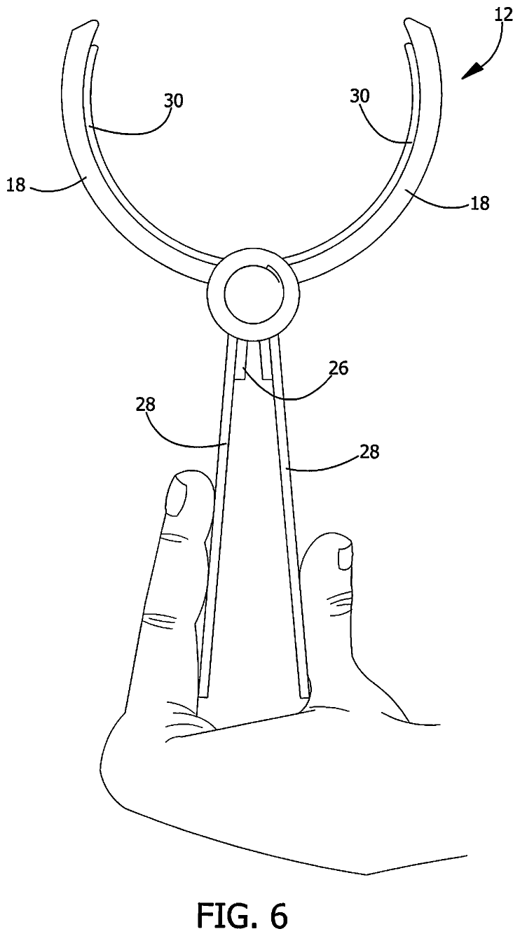

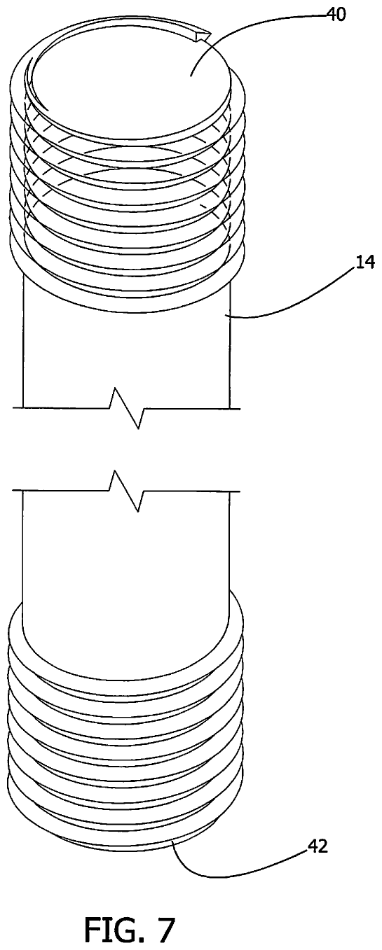

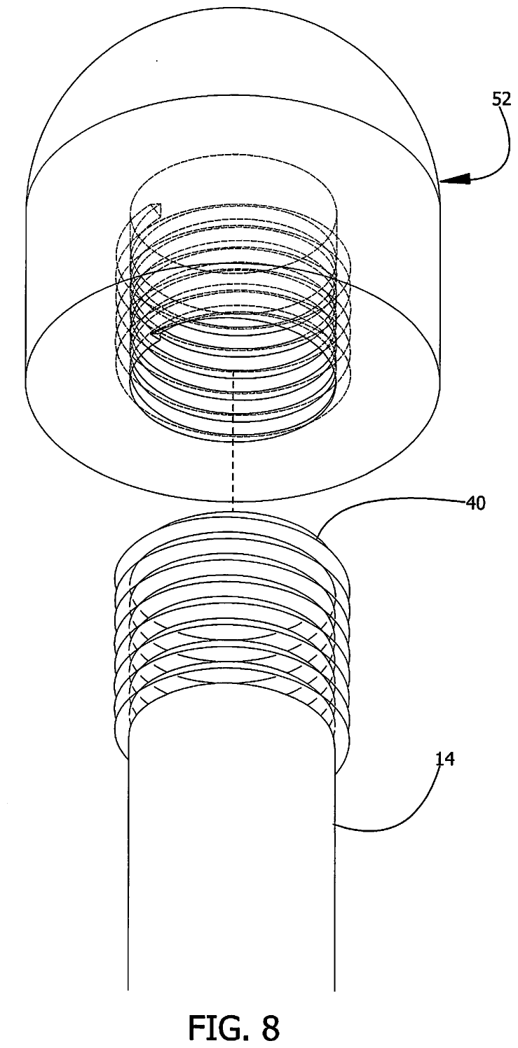

With reference now to the drawings, and in particular to FIGS. 1 through 10 thereof, a new flag assembly embodying the principles and concepts of an embodiment of the disclosure and generally designated by the reference numeral 10 will be described.

As best illustrated in FIGS. 1 through 10, the golf cart mountable flag assembly 10 generally comprises a clamp 12, a staff 14, and a flag 16. The clamp 12 comprises a pair of jaws 18, the jaws 18 of which are configured to be opened to receive a rod 20 of a canopy 22 of a golf cart 24 and to be closed such that the jaws 18 secure the clamp 12 to the rod 20. The clamp 12 typically will comprise a torsion spring 26, which is operationally engaged to the pair of jaws 18, and a pair of handles 28. The handles 28 are attached to the pair of jaws 18 and are operationally engaged to the torsion spring 26. The handles 28 are configured to be squeezed together to open the jaws 18 and to be released to close the jaws 18. The present invention anticipates the clamp 12 comprising other clamping means, such as, but not limited to, screw clamps, pipe clamps, or the like.

The grips 30 of a pair of grips 30 are attached singly to the pair of jaws 18 and are configured to frictionally engage the rod 20 upon closing of the jaws 18. The grips 30 comprise rubber, silicone, elastomer, or the like.

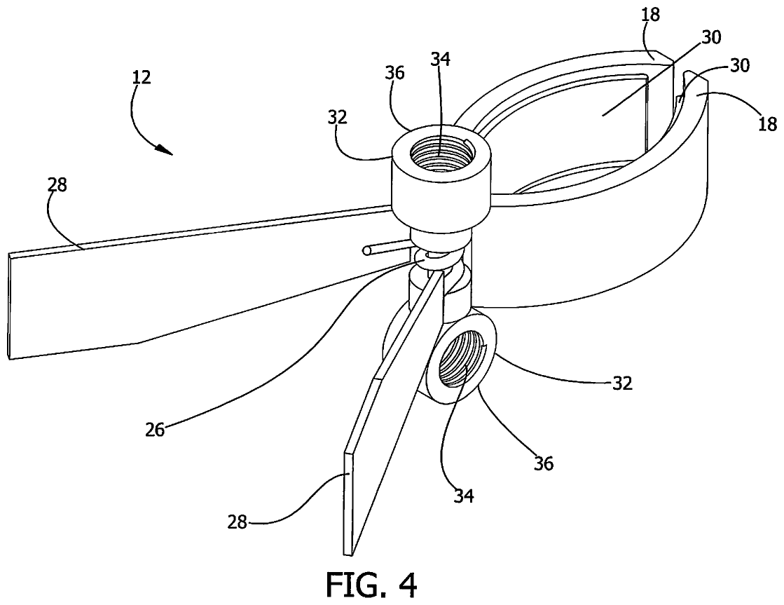

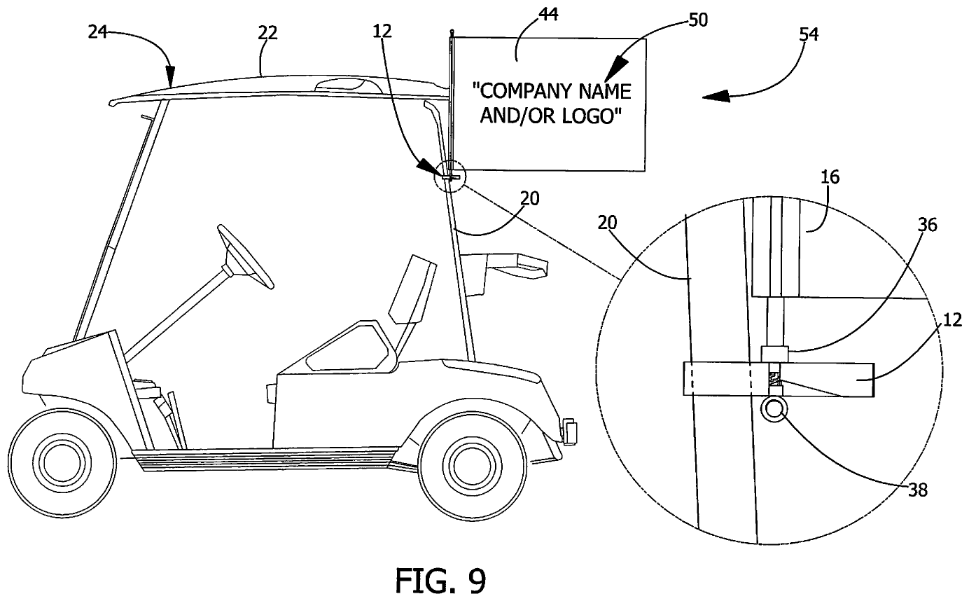

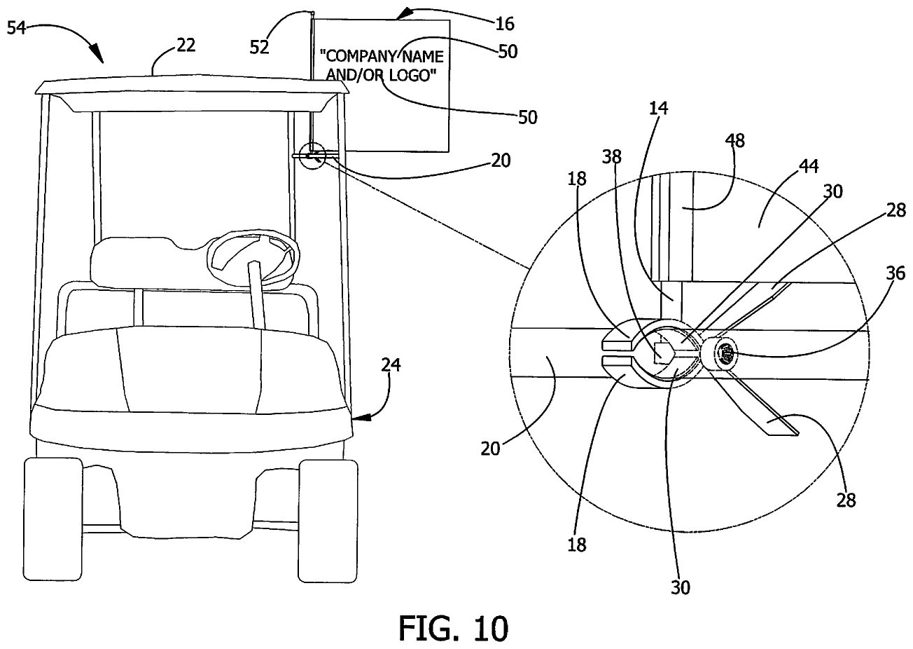

A socket 32 having an opening 34 is attached to the clamp 12 so that the opening 34 faces upwardly upon the clamp 12 being secured to the rod 20. As is shown in FIG. 4, the socket 32 is one of a pair of sockets 32. The opening 34 of a first socket 36 of the pair of sockets 32 faces upwardly upon attachment of the clamp 12 to a rod 20 of the canopy 22 that is substantially vertically oriented, as is shown in FIG. 9. The opening 34 a second socket 38 of the pair of sockets 32 faces upwardly upon attachment of the clamp 12 to a rod 20 of the canopy 22 that is substantially horizontally oriented, as is shown in FIG. 10.

The staff 14 has an upper end 40 and a lower end 42, with the lower end 42 being complimentary to and selectively insertable into the socket 32 so that the staff 14 is removably attached to the socket 32 and extends substantially vertically relative to a ground surface upon which the golf cart 24 is positioned. The staff 14 is externally threaded adjacent to the upper end 40 and the lower end 42. The opening 34 is internally threaded so that the lower end 42 of the staff 14 is threadedly insertable into the socket 32.

The flag 16 comprises a panel 44, which has a vertical edge 46, and a sleeve 48, which is attached to the panel 44 and which extends along the vertical edge 46. The staff 14 is insertable into the sleeve 48 to couple the flag 16 to the staff 14. Indicia 50 are attached to the panel 44 to advertise and promote businesses, products, organizations, causes, or the like. As is shown in the figures, the panel 44 may be rectangular. The present invention also anticipates the panel 44 being triangular, semicircular, or the like.

The golf cart mountable flag assembly 10 also includes a cap 52, which is removably attachable to the upper end 40 of the staff 14 to secure the flag 16 to the staff 14. Typically, the cap 52 is internally threaded and thus threadedly attachable to the upper end 40 of the staff 14.

The panel 44 typically will be flexible, although the present invention also anticipates the panel 44 being rigid or semirigid and thus maintaining a substantially planar configuration. The sleeve 48 may be rotatable around the staff 14 so that the panel 44 is biased to a position parallel to a breeze. The present invention also anticipates the sleeve 48 not being rotatable about the staff 14 so that the panel 44 is fixed relative to the staff 14 and the canopy 22, regardless of a direction of a breeze, as may be desired when using a panel 44 that is rigid or semirigid and which does not require a breeze for unfurling.

The present invention also includes a golf cart mounted flag system 54, which comprises a golf cart 24 and golf cart mountable flag assembly 10, as described in the specification above. A clamp 12 of the golf cart mountable flag assembly 10 is attached to a rod 20 of a canopy 22 of the golf cart 24 so that a staff 14 of the golf cart mountable flag assembly 10 extends substantially vertically relative to a ground surface upon which the golf cart 24 is positioned.

In use, the clamp 12 is attached to a rod 20 of a canopy 22 of a golf cart 24. The staff 14 then typically is inserted into the sleeve 48 by its upper end 40 and into the socket 32 by its lower end 42, thereby mounting the flag 16 to the golf cart 24 for display.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A golf cart mountable flag assembly comprising:
a clamp comprising a pair of jaws, the clamp being configured for opening to receive a rod of a canopy of a golf cart and for closing such that the jaws secure the clamp to the rod;
a socket having an opening and being attached to the clamp such that the opening faces upwardly upon securing of the clamp to the rod;
a staff having an upper end and a lower end, the lower end being complimentary to and selectively insertable into the socket such that the staff is removably attached to the socket and extends substantially vertically relative to a ground surface upon which the golf cart is positioned; and
a flag comprising:
a panel having a vertical edge; and
a sleeve being attached to the panel and extending along the vertical edge, the staff being insertable into the sleeve.

2. The golf cart mountable flag assembly of claim 1, wherein the clamp comprises:
a torsion spring being operationally engaged to the pair of jaws;
a pair of handles being attached to the pair of jaws and operationally engaged to the torsion spring, wherein the handles of the pair of handles being configured for squeezing together for opening the pair of jaws and for being released for closing the pair of jaws.

3. The golf cart mountable flag assembly of claim 1, further including a pair of grips are attached singly to the pair of jaws, wherein the grips are configured for frictionally engaging the rod upon closing of the jaws.

4. The golf cart mountable flag assembly of claim 3, wherein the grips comprise rubber, silicone, or elastomer.

5. The golf cart mountable flag assembly of claim 1, wherein the socket is one of a pair of sockets, the opening of a first socket of the pair of sockets facing upwardly upon attachment of the clamp to a rod of the canopy substantially vertically oriented, the opening a second socket of the pair of sockets facing upwardly upon attachment of the clamp to a rod of the canopy substantially horizontally oriented.

6. The golf cart mountable flag assembly of claim 1, wherein the panel is flexible.

7. The golf cart mountable flag assembly of claim 1, further including indicia being attached to the panel.

8. The golf cart mountable flag assembly of claim 1, further including a cap being removably attachable to the upper end of the staff for securing the flag to the staff.

9. The golf cart mountable flag assembly of claim 8, wherein:
the staff is externally threaded adjacent to the upper end and the lower end;
the opening is internally threaded such that the lower end of the staff is threadedly insertable into the socket; and
the cap is internally threaded such that the cap is selectively attachable to the upper end of the staff.

10. A golf cart mountable flag assembly comprising:
a clamp comprising a pair of jaws, the clamp being configured for opening to receive a rod of a canopy of a golf cart and for closing such that the jaws secure the clamp to the rod, the clamp comprising:
a torsion spring being operationally engaged to the pair of jaws;
a pair of handles being attached to the pair of jaws and operationally engaged to the torsion spring, wherein the handles of the pair of handles being configured for squeezing together for opening the pair of jaws and for being released for closing the pair of jaws;
a pair of grips are attached singly to the pair of jaws. the grips are configured for frictionally engaging the rod upon closing of the jaws, the grips comprising rubber, silicone, or elastomer;
a socket having an opening and being attached to the clamp such that the opening faces upwardly upon securing of the clamp to the rod, the opening being internally threaded, the socket being one of a pair of sockets, the opening of a first socket of the pair of sockets facing upwardly upon attachment of the clamp to a rod of the canopy substantially vertically oriented, the opening a second socket of the pair of sockets facing upwardly upon attachment of the clamp to a rod of the canopy substantially horizontally oriented;
a staff having an upper end and a lower end, the lower end being complimentary to and selectively insertable into the socket such that the staff is removably attached to the socket and extends substantially vertically relative to a ground surface upon which the golf cart is positioned, the staff being externally threaded adjacent to the upper end and the lower end;
a flag comprising:
a panel having a vertical edge, the panel being flexible;
a sleeve being attached so the panel and extending along the vertical edge, the staff being insertable into the sleeve;
indicia being attached to the panel; and
a cap being removably attachable to the upper end of the staff for securing the flag to the staff, the cap being internally threaded such that the cap is selectively attachable to the upper end of the staff.

11. A golf cart mounted flag system comprising:
a golf cart comprising a canopy, the canopy comprising at least one rod;
a clamp comprising a pair of jaws, the jaws being closed upon the rod such that the clamp is secured to the rod;
a socket having an opening and being attached to the clamp such that the opening faces upwardly;
a staff having an upper end and a lower end, the lower end being complimentary to and inserted into the socket such that the staff is removably attached to the socket and extends substantially vertically relative to a ground surface upon which the golf cart is positioned; and
a flag comprising:
a panel having a vertical edge; and
a sleeve being attached to the panel and extending along the vertical edge, the staff being inserted into the sleeve.
